(19) United States
(12) Patent Application Publication
(10) Pub. No.: US 2011/0022553 A1
(43) Pub. Date: Jan. 27, 2011

(54) DIAGNOSIS SUPPORT SYSTEM, DIAGNOSIS SUPPORT METHOD THEREFOR, AND INFORMATION PROCESSING APPARATUS

(75) Inventor: Keiko Yonezawa, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/893,989

(22) Filed: Sep. 29, 2010

Related U.S. Application Data
(63) Continuation of application No. PCT/JP2010/001989, filed on Mar. 19, 2010.

(30) Foreign Application Priority Data
Jun. 3, 2009 (JP) 2009-134297

(51) Int. Cl. G06F 15/18

(52) U.S. Cl. 706/12

(57) ABSTRACT

A diagnosis support system includes a learning unit which calculates a first learning result based on diagnosis results on case data which are obtained by a plurality of doctors and a second learning result based on a diagnosis result on the case data which is obtained by a specific doctor, an analysis unit which analyzes a feature associated with diagnosis by the specific doctor based on a comparison between the first learning result and the second learning result, and a decision unit which decides display information of clinical data obtained by examination of a patient based on the analysis result.

### TECHNICAL FIELD

The present invention relates to a diagnosis support system, a diagnosis support method therefor, and an information processing apparatus.

### BACKGROUND ART

Recently, various measurement instruments have been used in medical fields. These instruments generate an enormous information amount of data in the form of still images and moving images along with improvements in measurement accuracy and data processing capacity. This has greatly increased the loads on doctors who must interpret this data and perform diagnosis based on these data. One factor contributing to the increased load is the smaller number of doctors able to perform interpretation of data. The fostering of doctors capable of interpreting data is said to be an urgent need.

Computer-aided diagnosis (to be abbreviated as CAD hereinafter) techniques have attracted great attention. CAD is designed to support radiographic interpretation by using X-ray CT data and brain MRI data. There is known an education support system for the fostering of doctors capable of interpreting data, which displays the image information of a patient and surgical and medical findings and makes a learner answer a disease name, as disclosed in patent reference 1. This education support system displays a correct answer to the learner based on case data attached with an answer. This allows the learner to learn the diagnosis results on many cases that are obtained by medical specialists.

Citation List

Patent Literature

PLT1: Japanese Patent Laid-Open No. 5-25748

### SUMMARY OF INVENTION

### Technical Problem

In general, the above system displays the same answer to both an experienced doctor and an inexperienced doctor, and does not provide educational support in accordance with the experiences and the like. In the case of ophthalmology, for example, a doctor makes diagnosis by integrating the analysis results obtained by a plurality of modalities. In this case as well, this system displays the analysis results obtained by the respective modalities in equal proportions.

That is, the conventional system provides uniform educational support for a learner regarding each modality regardless of whether he/she is not good at it. In other words, this system does not provide educational support in accordance with learners.

The present invention has been made in consideration of the above problem, and has as its object to provide a technique of learning diagnosis patterns of individual doctors in advance and displaying diagnosis windows to the respective doctors in accordance with their diagnosis skills based on the learning results.

### Solution to Problem

In order to solve the above problem, a diagnosis support system according to an aspect of the present invention is characterized by comprising a learning unit which calculates a first learning result based on diagnosis results on case data which are obtained by a plurality of doctors and a second learning result based on a diagnosis result on the case data which is obtained by a specific doctor, an analysis unit which analyzes a feature associated with diagnosis by the specific doctor based on a comparison between the first learning result and the second learning result, and a decision unit which decides display information of clinical data obtained by examination of a patient based on the analysis result.

### ADVANTAGEOUS EFFECTS OF INVENTION

According to the present invention, this system learns diagnosis patterns of individual doctors in advance and displays diagnosis windows to the respective doctors in accordance with their diagnosis skills based on the learning results.

Other features and advantages of the present invention will be apparent from the following description taken in conjunction with the accompanying drawings, in which like reference characters designate the same or similar parts throughout the figures thereof.

### BRIEF DESCRIPTION OF DRAWINGS

The accompanying drawings, which are incorporated in and constitute a part of the specification, illustrate embodiments of the invention and, together with the description, serve to explain the principles of the invention.

FIG. 1 is a block diagram showing an example of the overall arrangement of a diagnosis support system according to an embodiment of the present invention;

FIG. 2 is a block diagram showing an example of the functional arrangement of a learning processing apparatus 10 shown in FIG. 1;

FIG. 3 is a flowchart showing an example of a processing procedure in the learning processing apparatus 10 shown in FIG. 1;

FIG. 4 is a flowchart showing an example of a processing procedure in step S104 shown in FIG. 3;

FIG. 5 is a view showing an example of the classification of case data;

FIG. 6 is a block diagram showing an example of the functional arrangement of a diagnosis support apparatus 50 shown in FIG. 1;

FIG. 7 is a flowchart showing an example of a processing procedure in the diagnosis support apparatus 50 shown in FIG. 1;

FIG. 8 is a view showing an example of the classification of case data;

FIG. 9 is a view showing an example of the functional arrangement of a learning processing apparatus 10 according to the third embodiment; and

FIG. 10 is a flowchart showing an example of a processing procedure in the learning processing apparatus 10 according to the third embodiment.

### DESCRIPTION OF EMBODIMENTS

An embodiment of a diagnosis support system, diagnosis support method therefor, and information processing apparatus according to the present invention will be described in detail below with reference to the accompanying drawings.

### First Embodiment

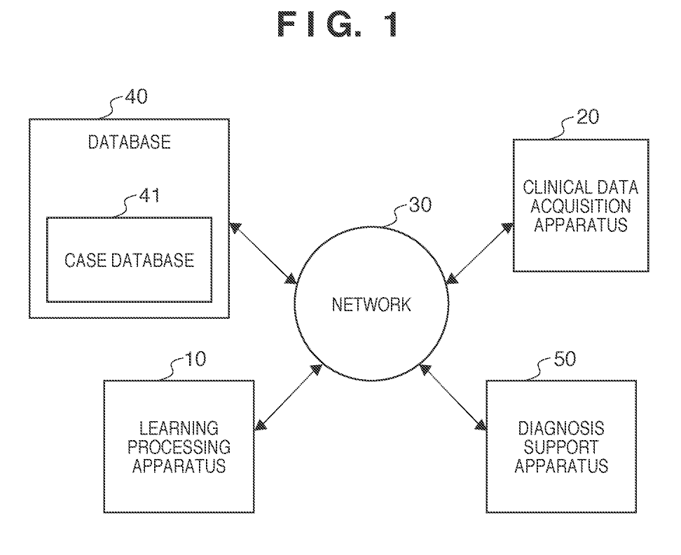

FIG. 1 is a block diagram showing an example of the overall arrangement of a diagnosis support system according to an embodiment of the present invention. This embodiment will exemplify diagnosis support for glaucoma.

A learning processing apparatus 10, a diagnosis support apparatus 50, a clinical data acquisition apparatus 20, and a database 40 are connected to this diagnosis support system via a network 30 constituted by a LAN (Local Area Network) and the like. Note that the respective apparatuses need not always be connected to each other via the network 30 as long as they can communicate with each other. For example, they may be connected to each other via a USB (Universal Serial Bus), IEEE1394, and the like, or may be connected to each other via a WAN (Wide Area Network).

In this case, the database 40 stores various kinds of data. The database 40 includes a case database 41. The case database 41 stores a plurality of case data such as data known to contain lesions and data containing no such lesions (no findings). In this case, the respective case data include the examination results obtained by using a plurality of modalities (for example, a fundus camera, OCT (Optical Coherence Tomograph), and perimeter). More specifically, these data include the fundus images captured by the fundus camera, the 3D images obtained by capturing tomograms of a macular portion and optic papillary area using the OCT, the measurement results on visual field sensitivity obtained by the perimeter, and the intraocular pressures, angles, visual acuities, and eye axis lengths of eyes to be examined.

The learning processing apparatus 10 learns the diagnosis pattern of a doctor and analyzes the features of the diagnosis made by the doctor. The learning processing apparatus 10 then stores the analysis result and the like in the database 40.

The clinical data acquisition apparatus 20 acquires clinical data. The clinical data includes the examination results obtained by using a plurality of modalities (for example, a fundus camera, OCT, and perimeter) like the above case data. The clinical data acquisition apparatus 20 executes imaging of an eye to be examined and measurement of visual field sensitivity, an intraocular pressure, an angle of the eye, and the like, and transmits the image obtained by the measurement and other pieces of information to the diagnosis support apparatus 50 in accordance with instructions from the diagnosis support apparatus 50.

The diagnosis support apparatus 50 is an apparatus used for diagnosis by a doctor. When the doctor performs diagnosis, the diagnosis support apparatus 50 acquires a learning result indicating the features of diagnosis made by the doctor from the database 40, and acquires the clinical data of a patient to be diagnosed from the clinical data acquisition apparatus 20. When the doctor makes diagnosis of a mistakable case, the diagnosis support apparatus 50 displays significant information for covering the mistake based on the clinical data. This provides diagnosis support in accordance with the diagnosis skill of each doctor.

Note that the learning processing apparatus 10, diagnosis support apparatus 50, clinical data acquisition apparatus 20, database 40, and the like incorporate computers. Each computer includes a main control unit such as a CPU and storage units such as ROM (Read Only Memory), RAM (Random Access Memory), and HDD (Hard Disk Drive). In addition, each computer includes input/output units such as a keyboard, mouse, display, buttons, and touch panel. These components are connected to each other via a bus and the like. The main control unit controls the components by executing programs stored in the storage unit.

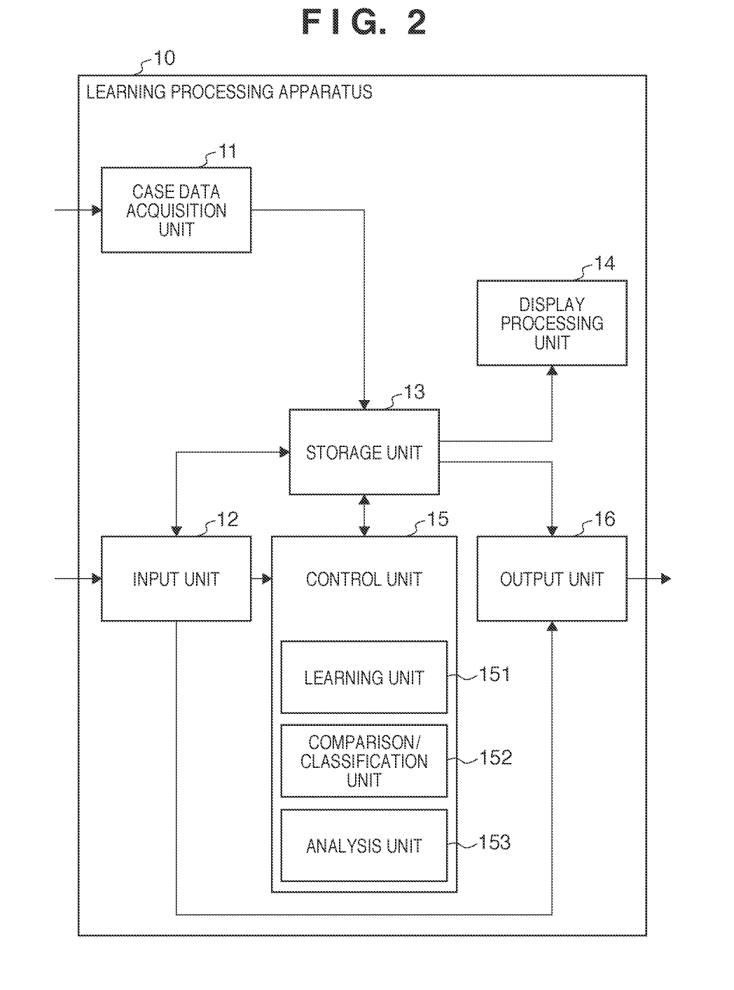

An example of the functional arrangement of the learning processing apparatus 10 shown in FIG. 1 will be described with reference to FIG. 2. The learning processing apparatus 10 includes a case data acquisition unit 11, an input unit 12, a storage unit 13, a display processing unit 14, an output unit 16, and a control unit 15.

The case data acquisition unit 11 acquires case data from the case database 41. The input unit 12 inputs identification information for identifying the doctor (user) and instructions from the user to the apparatus. The storage unit 13 stores various kinds of information. The control unit 15 comprehensively controls the learning processing apparatus 10. The display processing unit 14 generates a display window and displays it on a monitor (display unit). The output unit 16 outputs various kinds of information to the database 40 and the like.

In this case, the control unit 15 includes a learning unit 151, a comparison/classification unit 152, and an analysis unit 153. Based on the case data acquired by the case data acquisition unit 11, the learning unit 151 obtains a set of feature amounts necessary for identifying the case data. The learning unit 151 also sets parameters for a pattern recognition technique. The learning unit 151 then learns the diagnosis patterns of a plurality of experienced doctors (experients) and a doctor who uses this system by using the set of feature amounts, the parameters for the pattern recognition technique, and the like.

The comparison/classification unit 152 compares the learning result based on experients (to be referred to as the first learning result hereinafter) with the learning result based on the system user (to be referred to as the second learning result hereinafter) and classifies each case in the case database 41 based on the comparison result. In glaucoma diagnosis, for example, the comparison/classification unit 152 classifies the respective cases into a group of cases easy to identify as glaucoma, a group of cases easy to not identify as glaucoma (that is, identify as normal), a group of cases difficult to identify as glaucoma, and the like.

The analysis unit 153 analyzes the features of diagnosis (diagnosis skill) made by the system user based on the learning result based on experients (to be referred to as the first learning result) and the learning result based on the user (to be referred to as the second learning result hereinafter).

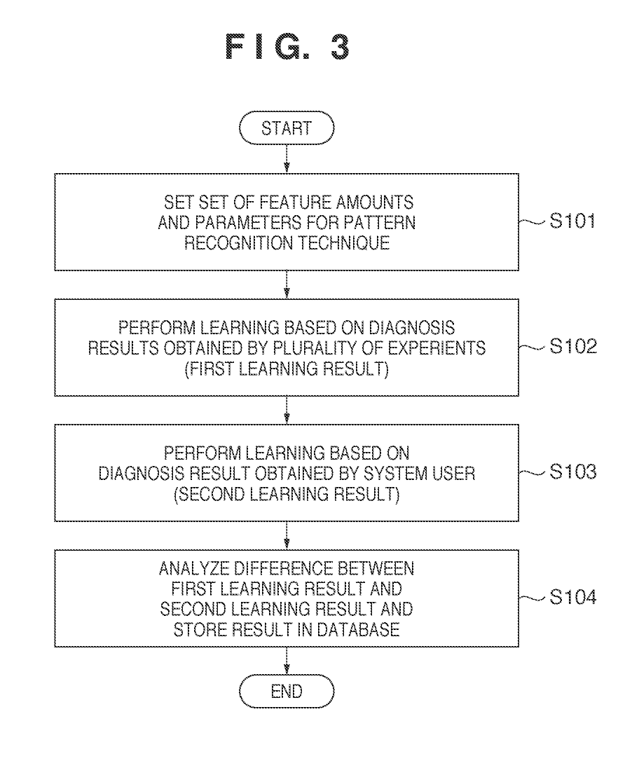

An example of a processing procedure in the learning processing apparatus 10 shown in FIG. 1 will be described next with reference to FIG. 3. The following is a processing procedure at the time of the generation of a learning result.

When this processing starts, the learning processing apparatus 10 causes the case data acquisition unit 11 to acquire case data attached with a diagnosis label (information indicating a diagnosis result) from the case database 41. The learning processing apparatus 10 then causes the learning unit 151 to decide a set of feature amounts while setting parameters for a pattern recognition technique and the like based on the case data attached with the diagnosis label and store these pieces of information in the storage unit 13 (S101). This processing is performed for all the case data stored in the case database 41.

In this case, the learning processing apparatus 10 causes the learning unit 151 to obtain the first discrimination function based on the diagnosis labels attached to the case data by a plurality of experienced doctors (experients) (S102). At this time, the learning unit 151 uses the values set in step S101 as a feature amount set and parameters for the pattern recognition technique.

The learning processing apparatus 10 causes the learning unit 151 to obtain the second discrimination function based on the diagnosis label attached to the case data by the doctor who uses this system (system user) (S103). The storage unit 13 stores the second discrimination function together with information for identifying the doctor (for example, the ID of each doctor). In this case, the learning unit 151 uses the values set in step S101 as a feature amount set and parameters for the pattern recognition technique.

The learning processing apparatus 10 causes the comparison/classification unit 152 to compare the learning result obtained by experients with that obtained by the system user, based on the first discrimination function obtained in step S102 and the second discrimination function obtained in step S103. The comparison/classification unit 152 classifies a case in the case database 41 based on the comparison result. Upon completing this classification, the learning processing apparatus 10 causes the analysis unit 153 to analyze the differences between the first discrimination function and the second discrimination function based on the classification result. The database 40 then stores the analysis result and the like (S104). Thereafter, the learning processing apparatus 10 terminates this processing.

[Details of Processing in Step S101]

A concrete example of the processing in step S101 shown in FIG. 3 will be described below.

In this case, the case database 41 stores a case N_{glaucoma} known as glaucoma and a normal case Nₙₒᵣₘₐₗ. Note that a case known as glaucoma indicates, for example, a case confirmed as glaucoma upon continuous follow-up after a medical specialist diagnoses the case as glaucoma.

The learning processing apparatus 10 causes the case data acquisition unit 11 to acquire all case data from the case database 41 and store them in the storage unit 13. Subsequently, the learning processing apparatus 10 causes the learning unit 151 to perform identification learning by pattern recognition using the acquired case data. For example, in the case of a fundus image, feature amounts used for pattern recognition include values such as a cup/disk ratio (C/D ratio) or rim/disk ratio (R/D ratio) corresponding to an excavation of an optic papillary area and a color histogram along a nerve fiber layer corresponding to a deficit of the nerve fiber layer. In the case of a 3D image obtained by the OCT, for example, a macular rim is segmented into nine sectors, and feature amounts include the thickness of the nerve fiber layer measured in each sector. In the case of visual field measurement, feature amounts include an MD value (Mean Deviation) and TD value (Total Deviation).

It is possible to perform pattern recognition by using, for example, an SVM (Support Vector Machine). Note that it is possible to use any techniques other than this technique as long as they can perform classification. For example, classification may be performed by using a parametric technique using a neutral network, Bayesian network, mixed normal distribution, or the like other than SVM.

In addition, as an evaluation method, for example, the 10 fold cross validation method may be used. This method divides glaucoma cases and normal cases into 10 groups, respectively, learns using nine groups of glaucoma cases and nine groups of normal cases, and identifies the remaining cases based on the learning result. The method repeats this processing. The 10 fold cross validation method is used to evaluate a correct answer ratio ((number of glaucoma cases identified as glaucoma+number of normal cases identified as normal)/total number of cases), and decides parameters for the pattern recognition technique so as to maximize the correct answer ratio.

In this case, a dimensionality reduction technique is used to select a feature amount effective for the identification of a case from a plurality of feature amounts. For example, a dimensionality reduction technique called a sequential backward search method is used. The sequential backward search method is a method of reducing feature amounts one by one from a state in which all the feature amounts are used. The sequential backward search method evaluates identification accuracy by this operation. However, the present invention is not limited to this technique. For example, it is possible to use a sequential forward search method of checking a change in accuracy by adding feature amounts one by one contrary to the above method, or a principal component analysis method known as a dimensionality reduction technique using no identifier.

Upon adjusting parameters by using all the feature amounts using the 10 fold cross validation method, this system performs dimensionality reduction by using the sequential backward search method. The system then changes the derived values of the parameters using their neighboring values, and checks changes in correct answer ratio. By repeating this processing, the system decides the final set of feature amounts and parameters for the pattern recognition technique.

In this manner, based on the case data acquired from the case database 41, the learning unit 151 decides a set of feature amounts and sets parameters (kernels and parameters) required to set a learning model. The storage unit 13 stores these parameters and the like, as described above. Note that in this processing, this system calculates sets of feature amounts for all the case data stored in the case database 41, and then stores a feature amount vector xᵢ (i=1 to N) for each case in the storage unit 13.

[Details of Processing in Step S102]

The detailed contents of the processing in step S102 shown in FIG. 3 will be described next. Assume that the system user is a doctor (experient) having rich experience in glaucoma diagnosis.

When this processing starts, the learning processing apparatus 10 causes the case data acquisition unit 11 to acquire case data from the case database 41 and store it in the storage unit 13. The acquired case data is stored in the storage unit 13 and is simultaneously displayed on the monitor via the display processing unit 14. The user diagnoses whether the case displayed on the monitor is glaucoma, and inputs the diagnosis result. This diagnosis result is input as a diagnosis label to the apparatus via the input unit 12, and is stored in the storage unit 13 in correspondence with the case data.

When labeling of all case data is complete, the learning processing apparatus 10 causes the learning unit 151 to perform learning based on the diagnosis labels attached by experients by using the feature amount sets of the respective cases and the parameters for the pattern recognition technique set in step S101. With this operation, the learning processing apparatus 10 obtains a discrimination function f₁.

In this case, the learning unit 151 performs learning based on the diagnosis made by a plurality of experienced doctors, and obtains discrimination functions based on the respective doctors. Let f₁¹ to f₁ⁿ be discrimination functions corresponding to n doctors. The storage unit 13 stores this learning result as the first learning result.

(Details of Processing in Step S103)

The processing in step S103 shown in FIG. 3 will be described with reference to a concrete example. Assume that a doctor (experienced or not) who uses this system is the system user.

When this processing starts, the learning processing apparatus 10 causes the input unit 12 to acquire identification information (ID information assigned to each doctor) for identifying the doctor. The learning processing apparatus 10 also causes the case data acquisition unit 11 to acquire case data from the case database 41 and store it in the storage unit 13. This acquired case data is stored in the storage unit 13 and is simultaneously displayed on the monitor via the display processing unit 14. The doctor who is the user diagnoses whether the case displayed on the monitor is glaucoma, and inputs the diagnosis result. This diagnosis result is input as a diagnosis label to the apparatus via the input unit 12 and is stored in the storage unit 13 in correspondence with the case data.

When labeling of all case data is complete, the learning processing apparatus 10 causes the learning unit 151 to perform learning based on the diagnosis label attached by the user by using the feature amount sets of the respective cases and the parameters for the pattern recognition technique set in step S101. With this operation, the learning unit 151 obtains a discrimination function f₂. The storage unit 13 stores this learning result as the second learning result together with the ID of the doctor who is the system user.

[Details of Processing in Step S104]

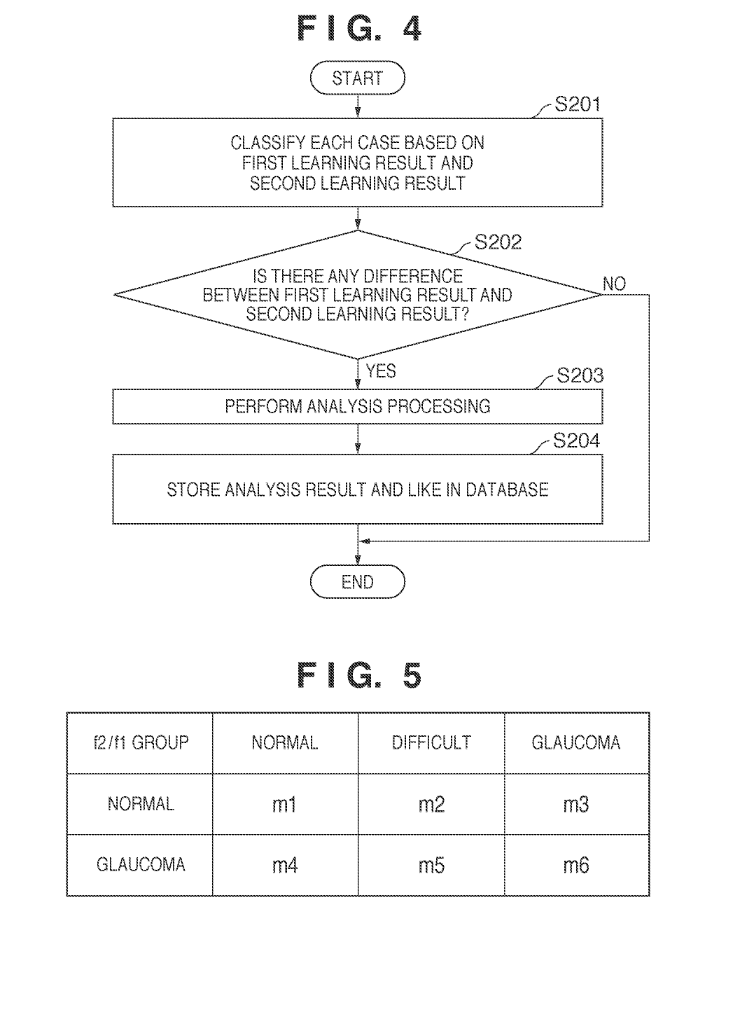

The processing in step S104 shown in FIG. 3 will be described with reference to FIG. 4 and a concrete example.

The learning processing apparatus 10 acquires the first learning result obtained in step S102 and the second learning result obtained in step S103 from the storage unit 13. In this case, the first learning result is a first discrimination function group f₁ⁿ(x) obtained by diagnosis made by a plurality of experienced doctors, and the second learning result is a second discrimination function f₂(x) obtained by the diagnosis made by the doctor as the system user.

In addition, the learning processing apparatus 10 acquires the value of a feature amount vector xᵢ (i=1 to N) corresponding to each case data calculated in step S101. The learning processing apparatus 10 then causes the comparison/classification unit 152 to classify the respective case data by using the first discrimination function group f₁ⁿ(x) and the second discrimination function f₂(x) (S201). With this operation, the respective case data are classified as shown in FIG. 5.

Referring to the abscissa in FIG. 5, when a given case is determined as normal by all n types of first discrimination functions f₁¹¹(x)to f₁ⁿ(x) and is also confirmed as normal, the case is normal, whereas when a given case is determined as glaucoma by all the n types of first discrimination functions f₁¹(x) to f₁ⁿ(x) and is also confirmed as glaucoma, the case is glaucoma. In addition, when at least one of the n types of first discrimination functions f₁¹(x) to f₁ⁿ(x) produces a confirmed diagnosis result on a given case which differs from the remaining confirmed diagnosis results, the case is classified as a difficult case. In addition, the ordinate in FIG. 5 shows the identification results based on the second discrimination function f₂(x). The respective cases are classified into six categories as a whole.

In this case, a case group m1 is a case group diagnosed as normal by both experients (a plurality of experienced doctors) and the system user (the doctor who uses this system). In addition, a case group m6 is a case group diagnosed as glaucoma by both the experients and the system user, and case groups m2 to m5 are case groups diagnosed differently among the experients, and can be said to be case groups difficult to diagnose (third category).

In contrast to this, a case group m3 is a case group diagnosed as glaucoma by all the experients but is diagnosed normal by the system user. That is, this is a case group regarding which the system user has overlooked glaucoma. The case group m3 is defined as a false negative case group (to be referred to as an FN case group hereinafter). In contrast, a case group m4 is a case group diagnosed as normal by all the experients but is diagnosed as glaucoma by the system user. That is, this case group is a false positive case group (to be referred to as an FP case group hereinafter) diagnosed by the system user.

Referring back to FIG. 4, when classification of case data is complete, the learning processing apparatus 10 causes the analysis unit 153 to determine whether there is any difference between the first discrimination function group f₁ⁿ(x) and the second discrimination function f₂(x). More specifically, the case groups classified as the case group m3 (FN) and the case group m4 (FP) are the differences between the above two functions. If there are no cases classified as the case group m3 (FN) or the case group m4 (FP), it is determined that there is no difference between the above two functions.

Upon determining that there is no difference (NO in step S202), the learning processing apparatus 10 terminates this processing. If there is a difference (YES in step S202), the learning processing apparatus 10 causes the analysis unit 153 to perform analysis processing (S203).

In this analysis processing, focus is placed on relationships (1) and (2) given below:

1) relationship between case group m3 (FN) and case group m1 (normal), and

2) relationship between case group m4 (FP) and case group m6 (glaucoma).

The cases classified as the case group m3 (FN) and the case group m1 (normal) are diagnosed as normal by the second discrimination function f₂. However, the case group m1 and the case group m3 are respectively diagnosed as normal and glaucoma by the first discrimination function group f₁ⁿ. That is, the case group m1 (first category) is a case group which the doctor as the system user has accurately diagnosed, whereas the case group m3 (second category) is a case group which the doctor has erroneously diagnosed.

The learning processing apparatus 10 causes the analysis unit 153 to refer to the case groups m3 and m1 to obtain a feature amount as a discrimination factor between the case group m3 and the case group m1. The analysis unit 153 obtains an optimal one-dimensional axis for identifying two classes in a feature amount space from the pattern distributions of the two classes by using, for example, the Fisher discriminant analysis method. Note that the present invention is not limited to the Fisher discriminant analysis method and may use, for example, a technique such as a decision tree or logistic regression analysis.

In this case, the analysis unit 153 applies Fisher discriminant analysis to the case groups m3 and m1. With this operation, the analysis unit 153 obtains a transformation matrix represented by “expression 1”.

M₃₁∝S_{w}⁻¹μₙ₃−μₙ₁)

where μ1 is the average vector of feature amount vectors in the respective case groups, and S_{w} is a intra-class scatter matrix. Letting x be the feature amount vector corresponding to each case classified as the case group m3 or the case group m1, the intra-class scatter matrix S_{w} is represented by “expression 2”.

$$\begin{matrix}{S}_{w} = {S}_{m 3} + {S}_{m 1} \\ = {\sum }_{i = m 3 , m 1} {\sum }_{x ∈ {m}_{i}} ( x - {μ}_{i} ) {( x - {μ}_{i} )}^{t}\end{matrix}$$

The analysis unit 153 obtains a transformation matrix M₃₁ by the Fisher discriminant analysis method. The feature amount space transformed by the transformation matrix M₃₁ is a one-dimensional space which maximizes the intra-class variation/inter-class variation ratio. Although not described here, the learning processing apparatus 10 obtains a transformation matrix M₄₆ by executing the above processing for the case groups m4 and m6.

Upon obtaining the transformation matrix, the learning processing apparatus 10 causes the analysis unit 153 to obtain one of the elements of M₃₁ which has the largest absolute value. A feature amount corresponding to this element is set as a most significant feature amount. The analysis unit 153 also calculates the sum of squares of the respective elements of M₃₁ for each modality. The analysis unit 153 then compares the calculated values for the respective modalities and sets, as a most significant modality, a modality exhibiting the largest value. This operation is performed to specify significant examination information when helping diagnosis by the doctor. Note that the analysis unit 153 also obtains a most significant feature amount and a most significant modality with respect to M₄₆.

Upon completing the analysis processing, the learning processing apparatus 10 transmits the analysis result and the like to the database 40. More specifically, the learning processing apparatus 10 stores, in the database 40, the set of feature amounts and the parameters for pattern recognition set in step S101, the first learning result obtained in step S102, the second learning result obtained in step S103, the ID of the doctor (system user), the analysis result obtained in step S104, and the like (S204).

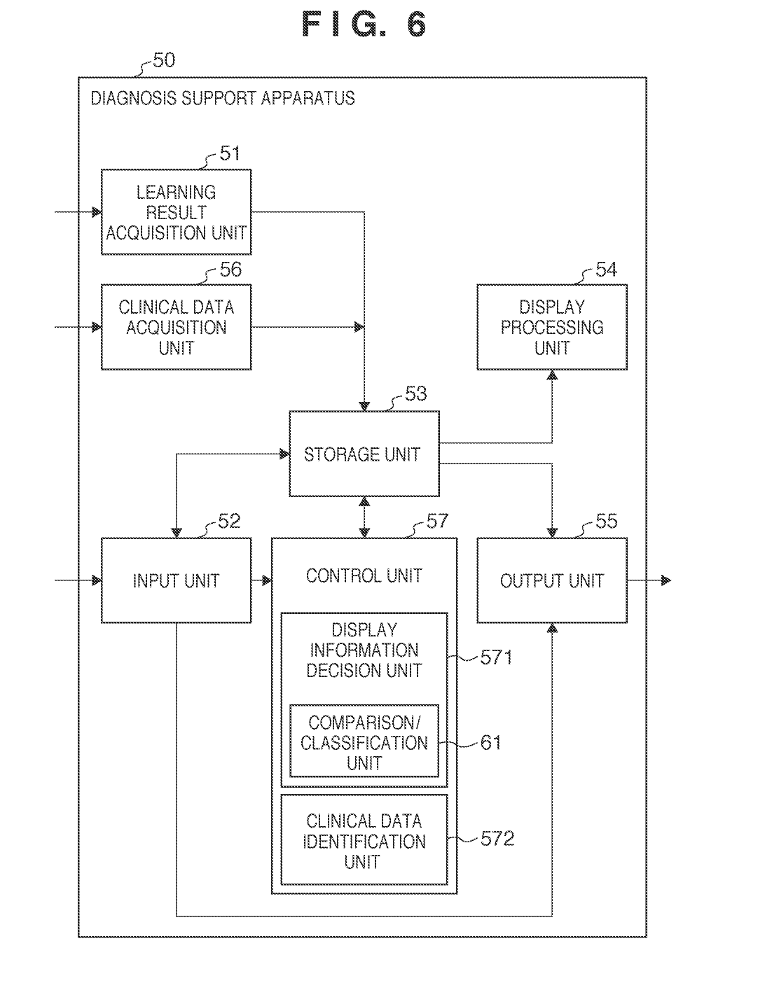

An example of the functional arrangement of the diagnosis support apparatus 50 shown in FIG. 1 will be described next with reference to FIG. 6. The diagnosis support apparatus 50 includes a learning result acquisition unit 51, an input unit 52, a storage unit 53, a display processing unit 54, an output unit 55, a clinical data acquisition unit 56, and a control unit 57.

The input unit 52 inputs information for identifying the doctor (user) and instructions from the user to the apparatus. The learning result acquisition unit 51 acquires learning results from the database 40. More specifically, the learning result acquisition unit 51 acquires the first learning result and the second learning result from the database 40.

The clinical data acquisition unit 56 acquires the clinical data of a patient to be diagnosed from the clinical data acquisition apparatus 20. The storage unit 53 stores various kinds of information. The control unit 57 comprehensively controls the diagnosis support apparatus 50. The display processing unit 54 generates a display window and displays it on the monitor. The output unit 55 outputs various kinds of information to the database 40 and the like.

In this case, the control unit 57 includes a display information decision unit 571 and a clinical data identification unit 572.

The display information decision unit 571 decides display information to be displayed on a window at the time of display of clinical data. Display information includes information indicating which of examination results is to be displayed at the time of display of clinical data and information indicating a specific modality by which the examination information to be displayed is obtained. The display information also includes information indicating how the examination result is displayed and information prompting to pay attention or the like. Note that the display information decision unit 571 decides which kind of display information is to be displayed, based on the analysis result obtained by the analysis unit 153.

The display information decision unit 571 includes a comparison/classification unit 61. The comparison/classification unit 61 classifies feature amount spaces into a plurality of categories by using the learning result based on the experients (to be referred to as the first learning result hereinafter) and the learning result based on the system user (to be referred to as the second learning result). The display information decision unit 571 decides display information for each classified category.

The clinical data identification unit 572 analyzes the clinical data acquired by the clinical data acquisition unit 56, and identifies a specific one of the categories classified by the comparison/classification unit 61 described above to which the clinical data is classified. More specifically, the clinical data identification unit 572 calculates the value of each feature amount based on the clinical data and obtains a feature amount vector x of the clinical data. With this operation, the clinical data identification unit 572 identifies to which case the clinical data is classified.

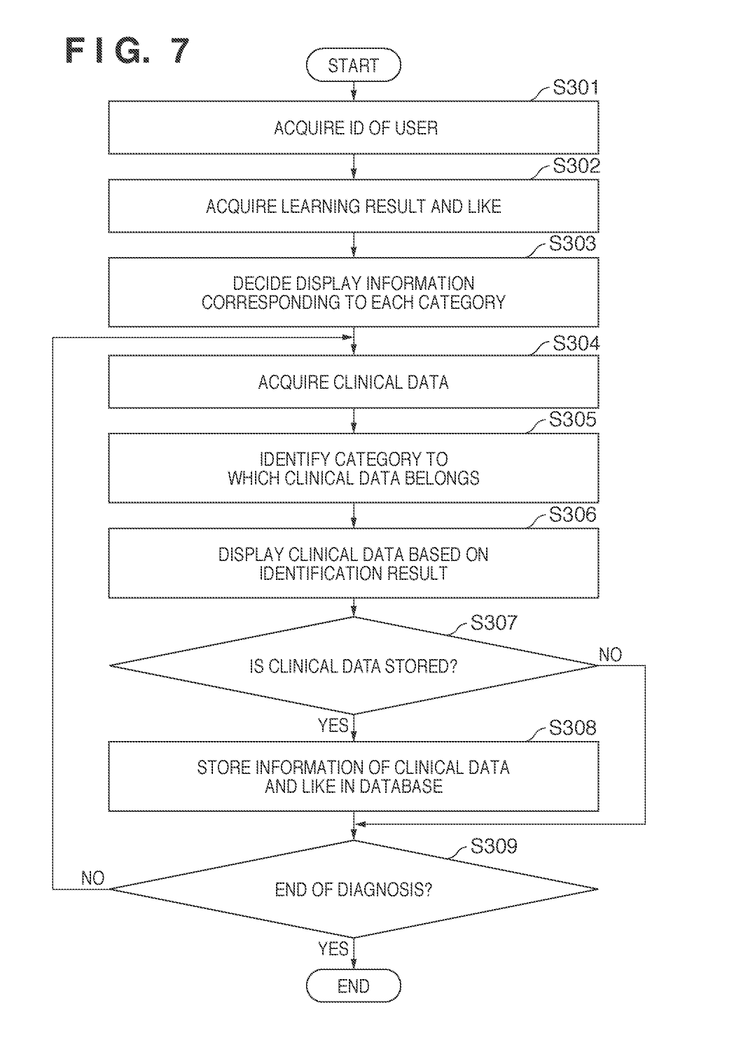

An example of a processing procedure in the diagnosis support apparatus 50 shown in FIG. 1 will be described next with reference to FIG. 7. The following is a processing procedure at the time of glaucoma diagnosis support.

First of all, the doctor inputs his/her ID via the input unit 52. With this operation, the diagnosis support apparatus 50 acquires the ID of the doctor (user) and stores it in the storage unit 53 (S301).

The diagnosis support apparatus 50 causes the learning result acquisition unit 51 to acquire information which the learning processing apparatus 10 stores in the database 40. More specifically, the learning result acquisition unit 51 acquires the feature amount set and the parameters for pattern recognition which are set in step S101 and the first learning result (the first discrimination function group f₁ⁿ(x)) obtained in step S102. The learning result acquisition unit 51 also acquires the second learning result (the second discrimination function f₂(x)) based on the doctor in step S103, based on the ID acquired in step S301, and also acquires the analysis result obtained by the user in step S104, based on the second learning result (S302).

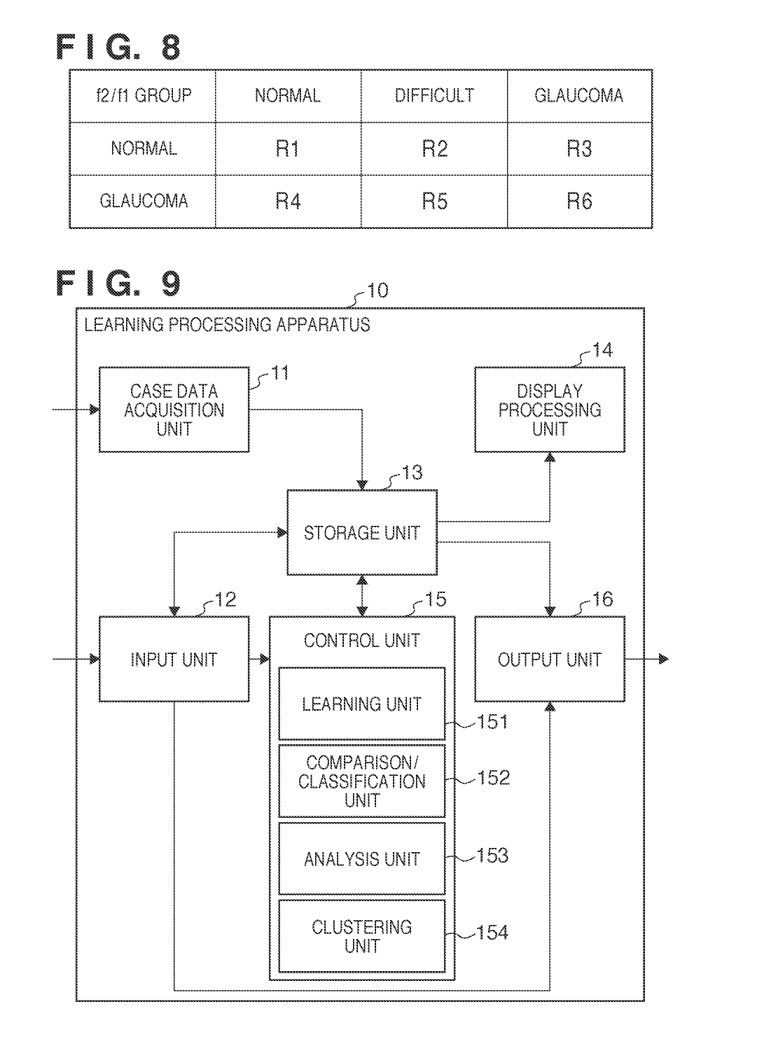

When the acquisition of these pieces of information is complete, the diagnosis support apparatus 50 causes the display information decision unit 571 to classify feature amount spaces into a plurality (six in this case) of categories by using the first discrimination function group f₁ⁿ(x) and the second discrimination function f₂(x), as shown in FIG. 8.

In this case, if there is no difference between the first discrimination function group f₁ⁿ(x) and the second discrimination function f₂(x), categories R3 and R2 are combined into the category R2, and the category R3 is regarded as not present. In addition, categories R4 and R5 are combined into the category R5, and the category R4 is regarded as not present. If there is a difference between the two functions, the display information decision unit 571 determines, based on the information acquired in step S302 (more specifically, the processing result in step S201), whether there is any case classified to either the category R3 (FN case group, m3) or the category R4 (FP case group, m4). If the determination result indicates that there is no FN case group, the categories R3 and R2 are combined into the category R2, and the category R3 is regarded as not present. If there is no FP case group, the categories R4 and R5 are combined into the category R5, and the category R4 is regarded as not present.

The diagnosis support apparatus 50 then causes the display information decision unit 571 to determine whether there is the category R3 or R4. Upon determining that either of the categories is present, the display information decision unit 571 acquires a most significant feature amount and a most significant modality corresponding to R3 and R4 from the storage unit 53 based on the information acquired in step S302 (more specifically, the processing result in step S203).

The diagnosis support apparatus 50 then causes the display information decision unit 571 to decide display information corresponding to each of a plurality of categories R1 to R6 (S303). More specifically, the display information decision unit 571 decides display information, of a plurality of pieces of display information provided in advance, which corresponds to each of the categories. For example, for the category R1, the display information decision unit 571 sets display information at the time of display of a case which is not glaucoma. For the category R6, the display information decision unit 571 sets display information at the time of display of a case which is glaucoma. For the category R2 or R5, the display information decision unit 571 sets display information at the time of display of a case which is difficult even for an experienced doctor to diagnose. For the category R3 or R4, the display information decision unit 571 sets display information at the time of display of information based on the most significant feature amount and the most significant modality obtained in step S203. In addition, the display information decision unit 571 selects display information at the time of display of information including an analysis result concerning each modality, display information at the time of display of information including a normal case distribution or a variation degree corresponding to each feature amount, or the like.

Upon deciding display information for each category, the diagnosis support apparatus 50 causes the clinical data acquisition unit 56 to acquire clinical data from the clinical data acquisition apparatus 20 (S304). More specifically, the clinical data acquisition unit 56 requests the clinical data acquisition apparatus 20 to transmit an examination result, acquires clinical data including fundus images, the 3D images obtained by the OCT, the measurement results on visual field sensitivity obtained by the perimeter, intraocular pressures, angles, visual acuities, and eye axis lengths, and stores them in the storage unit 53.

The diagnosis support apparatus 50 causes the clinical data identification unit 572 to calculate the value of each feature amount based on the clinical data acquired in step S304 and obtain the feature amount vector x of the clinical data. The clinical data identification unit 572 then executes identification processing for the calculated feature amount vector by using the first discrimination function group f₁ⁿ(x) obtained in step S102 and the second discrimination function f₂(x) obtained in step S103. With this operation, the clinical data identification unit 572 identifies a specific one of the categories of the feature amount spaces in FIG. 8 to which the case represented by the acquired clinical data belongs (S305).

The diagnosis support apparatus 50 causes the display processing unit 54 to display clinical data based on the identification result obtained by the clinical data identification unit 572 and the display information decided by the display information decision unit 571. That is, the display processing unit 54 generates a display window based on the display information set for the category to which the clinical data is classified, and displays the display window on the monitor (S306).

When the diagnosis is complete, the doctor issues an instruction to store or not to store the clinical data in the database 40 via the input unit 52. If the doctor issues an instruction to store (YES in step S307), the diagnosis support apparatus 50 causes the output unit 55 to transmit the ID of the doctor, clinical data, analysis result, and the like to the database 40 (S308). The diagnosis support apparatus 50 further stores the diagnosis result (diagnosis label) obtained by the doctor in the database 40 in correspondence with the clinical data.

Subsequently, the doctor issues an instruction to terminate or not to terminal the diagnosis via the input unit 52. If the doctor operates to issue an instruction to terminate the diagnosis (YES in step S309), the diagnosis support apparatus 50 terminates this processing. If the doctor operates to issue an instruction to continue the diagnosis (NO in step S309), the process returns to the processing in step S304.

The display window displayed on the monitor in step S306 will be described below with reference to an example.

When displaying a case easy to identify as no glaucoma (clinical data classified to the category R1), the monitor displays, for example, a fundus image having good browsability as a whole in the center of the window while displaying a tomogram obtained by imaging a middle portion of the macular portion on a side of the fundus image. The result obtained by the perimeter is displayed below the OCT tomogram because it is predicted that there will be no deterioration in sensitivity. The values of the clinical data are also displayed in the window. It is preferable to form a window composition so as to have image data in the center as a whole and not to display analysis results more than necessary.

When displaying a case easy to identify as glaucoma (clinical data classified to the category R6), the diagnosis support apparatus 50 displays a detection result on a nerve fiber layer deficit and a measurement result (C/D ratio or the like) on an excavation of an optic disk rim within the fundus image. The diagnosis support apparatus 50 also displays an overall image of the thickness map of the nerve fiber layer obtained by the OCT. The diagnosis support apparatus 50 displays the measurement result obtained by the perimeter, together with a sensitivity distribution map such that the analysis result based on an index indicating the degree of visual field abnormality is displayed juxtaposed. Although various techniques of analyzing the degree of visual field abnormality are known, for example, an Anderson classification system or the like may be used. When a glaucoma case is to be displayed, it is preferable to perform category classification based on the determination criterion set by the Tajimi study or the like.

When displaying a case difficult to identify as glaucoma (clinical data classified to the category R2 or R5), the diagnosis support apparatus 50 displays an alert (to attract attention) indicating that diagnosis is difficult, in addition to the display of the category R6 described above. In displaying such a case, information such as fundus findings based on a slit lamp may be important in addition to the above feature amounts. It is therefore preferable to display information about points to which general medical specialists direct their attention, together with the feature amounts used for learning.

When displaying an FN case group or FP case group (cases classified to the category R3 or R4), the diagnosis support apparatus 50 forms a display window based on the above most significant feature amount and most significant modality. In general, some doctor may be unfamiliar with the interpretation of OCT images or unfamiliar with a new analysis mode of the perimeter, even though he/she has rich experience in the interpretation of fundus images. Consider a case in which, for example, the most significant feature amount is a feature amount associated with the thickness of the nerve fiber layer, and the most significant modality is the OCT. In this case, the diagnosis support apparatus 50 displays a layer thickness distribution in a normal case and data associated with variations in the distribution, in addition to the layer thickness map of the thicknesses of the nerve fiber layer around the macula. In addition, the diagnosis support apparatus 50 displays an indication indicating a portion with a large shift from the normal distribution of a case to be examined, a tomogram of the portion with the large shift, and the like.

For example, it is known that an intraocular pressure is influenced by various factors. For this reason, when a most significant feature amount is an intraocular pressure, data concerning fluctuations is displayed. For example, it is possible to display data concerning age, sex, race, the influence of refraction, the difference between variations appearing when an object is in a sitting position and variations appearing when the object is in a supine position, and the like.

The above description has presented several examples of the manner of display with respect to various feature amounts and modalities. Obviously, as necessary information changes, the corresponding display window changes. For example, with regard to data associated with variations in intraocular pressure, when a new examination result is presented, the contents to be displayed are changed accordingly.

As described above, according to the first embodiment, this system compares the diagnosis patterns of a plurality of experienced doctors and the diagnosis pattern of the doctor who uses the system, and analyzes the differences between them. The system then changes the display contents of the diagnosis window based on the analysis result. With this operation, when, for example, a plurality of doctors diagnose the same case, the system can display, to a doctor who tends to make diagnosis errors on the case, information covering such errors, and display normal information to other doctors.

### Second Embodiment

The second embodiment will be described next. The first embodiment has exemplified the case in which a diagnosis window is displayed for each modality as a unit. In contrast to this, the second embodiment will focus attention on the fact that the same modality produces a plurality of different imaging results, analysis results, and the like. For example, a modality called OCT is used to image a macula and an optic papillary rim. A modality called fundus camera is used to analyze an optic papillary area in a fundus image and a nerve fiber deficit.

The second embodiment therefore further classifies most significant modalities and obtains a most significant imaged portion or most significant analysis portion. More specifically, the second embodiment differs from the first embodiment in the processing in step S203.

In this case, a learning processing apparatus 10 according to the second embodiment causes an analysis unit 153 to obtain one of the elements of a transformation matrix M₃₁ which has the largest absolute value, and sets a feature amount corresponding to the element as a most significant feature amount. The analysis unit 153 also calculates the sum of squares of the respective elements of M₃₁ for each corresponding imaged portion. The analysis unit 153 then sets an imaged portion exhibiting the largest sum of squares as a most significant imaged portion. If, for example, there are an OCT image obtained by imaging a macular portion and an OCT image obtained by imaging an optic papillary area, the analysis unit 153 calculates the sum of squares of the respective elements of M₃₁ corresponding to the feature amount of the macular portion and the sum of squares of the respective elements of M₃₁ corresponding to the feature amount of the optic papillary area.

For example, when analyzing a fundus image, this system may analyze a plurality of analysis portions such as an optic papillary area, a nerve fiber deficit of the upper half of the fundus, and a nerve fiber deficit of the lower half of the fundus. For this reason, the system obtains the sums of squares of the respective elements of M₃₁ corresponding to feature amounts associated with the respective analysis portions, and compares the obtained values for the respective analysis portions. The system then sets an analysis portion exhibiting the largest sum of squares as a most significant analysis portion. Note that the system obtains a most significant feature amount and a most significant imaged portion or most significant analysis portion for M₄₆ in the same manner as described above.

Accordingly, the processing in steps S302 and S303 executed by a diagnosis support apparatus 50 differs from that in the first embodiment. In the processing in step S302, the diagnosis support apparatus 50 acquires not only a most significant modality but also a most significant imaged portion or most significant analysis portion of the modality. More specifically, if there is a case classified to R3 or R4, the diagnosis support apparatus 50 acquires a most significant feature amount and a most significant imaged portion or most significant analysis portion.

In addition, in the processing in step S303, the diagnosis support apparatus 50 causes a display information decision unit 571 to decide display information for each of a plurality of categories R1 to R6. More specifically, although the same pieces of display information as those in the first embodiment are set for the categories R1, R2, R5, and R6, display information corresponding to a most significant feature amount and a most significant imaged portion or most significant analysis portion is set for the category R3.

As described above, according to the second embodiment, this system performs display based on not only a modality but also an imaged portion or analysis portion based on the modality. Therefore, when using, for example, a modality called OCT, the system can preferentially display information about an optic papillary area in particular.

### Third Embodiment

The third embodiment will be described next. According to the first embodiment, when analyzing the differences between the diagnosis patterns of a plurality of experienced doctors and the diagnosis pattern of a doctor who uses this system, the system handles an FP case group and an FN case group as one set. However, for example, in cases (FN case group) in which the doctor overlooks glaucoma, there are a plurality of factors that cause the overlooking. For this reason, an FN case group should be further divided into classes.

In the third embodiment, therefore, this system performs clustering processing for case groups (FP case group and FN case group) in a specific category. With this operation, the system obtains a most significant feature amount and most significant modality reflecting the internal structure of each case group.

An example of the functional arrangement of a learning processing apparatus 10 according to the third embodiment will be described first with reference to FIG. 9. The same reference numerals as in FIG. 2 with reference to which the first embodiment has been described denote the same components in FIG. 9, and a description of them will be omitted.

A control unit 15 of the learning processing apparatus 10 is newly provided with a clustering unit 154. The clustering unit 154 further classifies an FP case group and FN case group. For clustering, it is possible to use, for example, the k-means method or a technique using a mixed normal distribution.

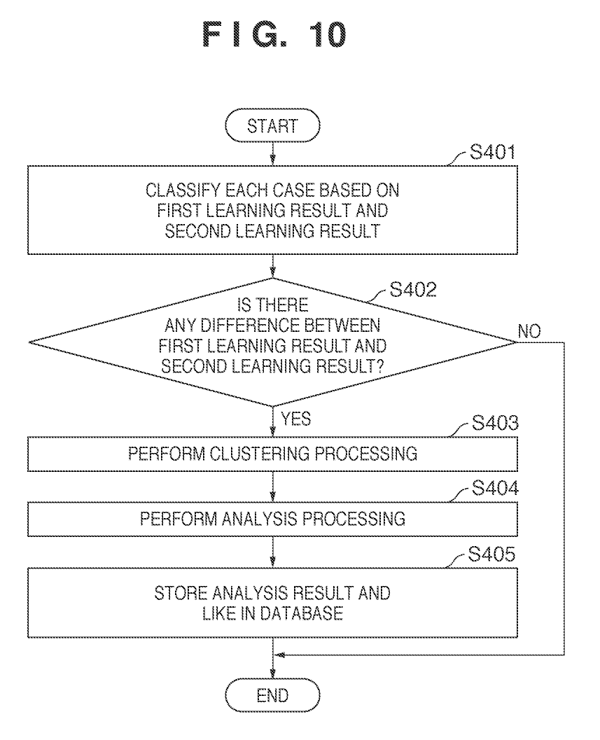

An example of a processing procedure in the learning processing apparatus 10 according to the third embodiment will be described next with reference to FIG. 10. Differences from FIG. 3 with reference to which the first embodiment has been described will be described below.

As in the first embodiment, the learning processing apparatus 10 classifies each case data (S401). The learning processing apparatus 10 then causes a comparison/classification unit 152 to determine whether there is any difference between a first discrimination function group f₁ⁿ(x) and a second discrimination function f₂(x).

Upon determining that there is a difference (YES in step S402), the learning processing apparatus 10 causes the clustering unit 154 to perform clustering processing (S403). More specifically, the clustering unit 154 classifies a case group m3 and a case group m4 into k₃ clusters and k₄ clusters, respectively. As a result, the clustering unit 154 obtains m3-1 to m3-k₃ and m4-1 to m4-k₄.

In this case, a count k₃ of clusters is decided in accordance with the distribution of the case group m3 in the feature amount space. For example, the clustering unit 154 performs clustering by using the k-means method while incrementing the count from k₃=2 one by one. The maximum value of the cluster count is set under conditions that, for example, the convergence result of the feature amount vector of the case group m3 does not vary in accordance with an initial value and at least five cases are assigned to each cluster.

The learning processing apparatus 10 then obtains the relationship between the cluster count and the sum of squares of the distances from the average vectors of clusters to which the respective samples in the case group m3 are assigned. The learning processing apparatus 10 then selects a cluster count exhibiting a large decrease in sum of squares with an increase in cluster count.

Upon completing the clustering processing, the learning processing apparatus 10 causes an analysis unit 153 to perform analysis processing (S404). In this analysis processing, the learning processing apparatus 10 substitutes the case group m3 (FN) for k₃ clusters m3-1 to m3-k₃, and substitutes the case group m4 (FP) for k₄ clusters m4-1 to m4-k₄.

More specifically, with the above processing, the learning processing apparatus 10 sets the following clusters:

1-1) case group m3 (FN)-1 and case group m1 (normal)
1-2) case group m3 (FN)-2 and case group m1 (normal)
. . .
1-k) case group m3 (FN)-k₃ and case group m1 (normal); and
2-1) case group m4 (FP)-1 and case group m6 (glaucoma)
2-2) case group m4 (FP)-2 and case group m6 (glaucoma)
. . .
2-k) case group m4 (FP)-k₄ and case group m6 (glaucoma)

The learning processing apparatus 10 causes the analysis unit 153 to execute the same analysis as that in the first embodiment for 1-1) to 1-k3) and 2-1 to 2-k₄). With this processing, the learning processing apparatus 10 acquires transformation matrices M₃₁-1 to M₃₁-k₃ and M₄₆-1 to M₄₆-k₄ as analysis results.

Upon obtaining transformation matrices, the learning processing apparatus 10 causes the analysis unit 153 to obtain one of the elements of M₃₁-1 which has the largest absolute value, and sets a feature amount corresponding to the element as a most significant feature amount, as in the first embodiment. The analysis unit 153 calculates the sum of squares of the respective elements of M₃₁-1 for each modality. The analysis unit 153 compares these values for each modality, and sets a modality exhibiting the largest value as a most significant modality. Likewise, the analysis unit 153 obtains most significant feature amounts and most significant modalities for all the transformation matrices M₃₁-1 to M₃₁-k₃ and M₄₆-1 to M₄₆-k₄. Note that the analysis unit 153 obtains a most significant feature amount and a most significant modality for M₄₆-1 in the same manner as described above.

Upon obtaining analysis results in this manner, the learning processing apparatus 10 stores, in a storage unit 13, the analysis results as most significant feature amounts and most significant modalities for the respective clusters. Obviously, as in the second embodiment, it is possible to obtain most significant feature amounts and most significant imaged portions or most significant analysis portions.

An example of a processing procedure in a diagnosis support apparatus 50 according to the third embodiment will be described next. Note that since the processing procedure in the diagnosis support apparatus 50 is the same as that in FIG. 7 of the first embodiment, the differences from the processing procedure in the first embodiment will be described below with reference to FIG. 7.

Upon acquiring a learning result and the like in step S302 as in the first embodiment, the diagnosis support apparatus 50 causes a display information decision unit 571 to classify feature amount spaces into a plurality (six in this case) of categories, as shown in FIG. 8. The display information decision unit 571 then performs category combining and the like, as in the first embodiment. If there is a feature amount space corresponding to a category R3 (FN case group) as a result of this category combining and the like, the display information decision unit 571 classifies the category R3 to one of the k₃ clusters described in step S403. The display information decision unit 571 also classifies a category R4 (FP case group) into k₄ clusters like the category R3.

The diagnosis support apparatus 50 then causes the display information decision unit 571 to determine whether there is the category R3 or R4. Upon determining that one of the categories is present, the display information decision unit 571 acquires most significant feature amounts and most significant modalities corresponding to the category R3 and its clusters R3-1 to R3-k₃ or the category R4 and its clusters R4-1 to R4-k₄.

The diagnosis support apparatus 50 then causes the display information decision unit 571 to decide display information for each of a plurality of categories (S303). That is, the display information decision unit 571 decides pieces of display information corresponding to four types of categories R1, R2, R5, and R6, two types of categories, and clusters R3-1 to R3-k₃ and R4-1 to R4-k₄ belonging to the respective categories. The display information decision unit 571 sets pieces of display information corresponding to most significant feature amounts and most significant modalities for the respective clusters R3-1 to R3-k₃ of the category R3 and the classes R4-1 to R4-k₄ of the category R4.

Upon deciding display information corresponding to each category, the diagnosis support apparatus 50 acquires clinical data (S304), and obtains a feature amount vector x of the clinical data. With this operation, the diagnosis support apparatus 50 identifies a specific feature amount space (of the six categories and corresponding clusters) shown in FIG. 8 to which the case represented by the acquired clinical data belongs (S305). If, for example, the diagnosis support apparatus 50 uses the k-means method as a cluster identification method in step S403, the apparatus classifies the case to one of the clusters which has an average vector with the shortest distance.

The diagnosis support apparatus 50 then causes a display processing unit 54 to display clinical data based on the identification result obtained by the clinical data identification unit 572 and the display information decided by the display information decision unit 571. That is, the display processing unit 54 generates a display window based on the display information set for the category to which the clinical data is classified, and displays the information on the monitor (S306). Note that since the subsequent processing is the same as that in the first embodiment, a description of the processing will be omitted.

As described above, according to the third embodiment, this system can display a more optimal diagnosis window in diagnosing a case which causes a diagnosis error (FP or FN) at a high possibility.

Although examples of the representative embodiments of the present invention have been described above, the present invention is not limited to the above embodiments shown in the accompanying drawings and can be modified and executed as needed within the spirit and scope of the present invention.

For example, according to the above description (FIGS. 7 and 10 and the like), the diagnosis support apparatus 50 is configured to perform category identification processing and clustering processing for each diagnosis. However, the present invention is not limited to this. For example, the apparatus may be configured to hold the results obtained by performing category identification and clustering once and subsequently provide diagnosis support by acquiring the results.

The above diagnosis support system includes the learning processing apparatus 10, diagnosis support apparatus 50, clinical data acquisition apparatus 20, and database 40. However, the system need not always employ such an arrangement. That is, it suffices if any of the apparatuses in the system implements all or some of the functions. For example, the learning processing apparatus 10 and the diagnosis support apparatus 50 may be implemented as one apparatus (information processing apparatus), or may be implemented as three or more apparatuses.

### Other Embodiments

The present invention is also implemented by executing the following processing. This processing is the processing of supplying software (programs) for implementing the functions of the above embodiments to a system or apparatus via a network or various kinds of storage media, and causing the computer (or the CPU, MPU, or the like) of the system or apparatus to read out and execute the programs.

The present invention is not limited to the above embodiments and various changes and modifications can be made within the spirit and scope of the present invention. Therefore, to apprise the public of the scope of the present invention, the following claims are made.

This application claims the benefit of Japanese Patent Application No. 2009-134297, filed on Jun. 3, 2009, which is hereby incorporated by reference herein in its entirety.

1. A diagnosis support system comprising:
a learning unit configured to calculate a first learning result based on diagnosis results of case data diagnosed by a plurality of doctors and a second learning result based on a diagnosis result of the case data diagnosed by a specific doctor;
an analysis unit configured to analyze a feature associated with diagnosis by the specific doctor based on a comparison between the first learning result and the second learning result; and
a decision unit configured to decide display information of clinical data obtained by examination of a patient based on the analysis result.

2. A diagnosis support system comprising:
an input unit configured to input identification information for identifying a doctor;
a learning unit configured to calculate a first learning result based on diagnosis results of case data diagnosed by a plurality of doctors and a second learning result based on a diagnosis result of the case data diagnosed by a doctor corresponding to the identification information input by said input unit;
an analysis unit configured to analyze a feature associated with diagnosis by the doctor corresponding to the identification information input by said input unit based on a comparison between the first learning result and the second learning result;
a clinical data acquisition unit configured to acquire clinical data obtained by examination of a patient;
a decision unit configured to decide display information of the clinical data based on the analysis result; and
a display processing unit configured to display, on a display device, a display window based on the display information decided by said decision unit.

3. The diagnosis support system according to claim 2, further comprising:
a classification unit configured to classify the case data into a plurality of categories by using the first learning result and the second learning result; and
an identification unit configured to identify a specific one of the categories classified by said classification unit to which the clinical data belongs, based on a feature amount of the clinical data and a feature amount of the case data,
wherein said classification unit classifies the case data into a plurality of categories including a first category to which a case group accurately diagnosed by the doctor corresponding to the identification information input by said input unit belongs and a second category to which an erroneously diagnosed case group belongs,
said analysis unit specifies significant examination information for helping diagnosis by the doctor corresponding to the identification information input by said input unit, based on the case groups classified to the first category and the second category, and
said decision unit decides the display information based on the examination information specified by said analysis unit when said identification unit identifies that the clinical data belongs to the second category.

4. The diagnosis support system according to claim 3, further comprising a clustering unit configured to classify case data classified to the second category by said classification unit into a plurality of clusters,
wherein said identification unit identifies a specific one of the plurality of clusters to which the clinical data belongs, based on a feature amount of the clinical data and a feature amount of the case data, when the clinical data acquired by said clinical data acquisition unit belongs to the second category, and
said decision unit decides the display information based on the examination information specified by said analysis unit in correspondence with a cluster of the second category, when said identification unit identifies that the clinical data belongs to the second category.

5. The diagnosis support system according to claim 3, wherein said classification unit uses the first learning result, based on diagnosis results of the case data diagnosed by a plurality of doctors, to classify the case data to a third category to which a case group differently diagnosed by the plurality of doctors belongs,
said analysis unit specifies significant examination information for helping diagnosis by the doctor corresponding to the identification information input by said input unit, based on the case group classified to the third category, and
said decision unit decides the display information based on the examination information specified by said analysis unit, when said identification unit identifies that the clinical data belongs to the third category.

6. The diagnosis support system according to claim 3, wherein the clinical data includes a plurality of examination results obtained by examining the patient by using a plurality of modalities, and
the examination information includes at least one of information indicating one of the plurality of examination results, information indicating by which one of the plurality of modalities examination has been performed, and information indicating a plurality of imaged portions obtained by examination using the modalities or one of the imaged portions.

7. A diagnosis support method for a diagnosis support system, comprising the steps of:
calculating a first learning result based on diagnosis results of case data diagnosed by a plurality of doctors and a second learning result based on a diagnosis result of the case data diagnosed by a specific doctor;
analyzing a feature associated with diagnosis by the specific doctor based on a comparison between the first learning result and the second learning result; and
deciding display information of clinical data obtained by examination of a patient based on the analysis result.

8. An information processing apparatus comprising:
an input unit configured to input identification information for identifying a doctor;
a learning unit configured to calculate a first learning result based on diagnosis results of case data diagnosed by a plurality of doctors and a second learning result based on a diagnosis result of the case data diagnosed by a specific doctor corresponding to identification information input by said input unit; and
an analysis unit configured to analyze a feature associated with diagnosis by the specific doctor based on a comparison between the first learning result and the second learning result.

9. An information processing apparatus comprising:
an input unit configured to input identification information for identifying a doctor;
a clinical data acquisition unit configured to acquire clinical data obtained by examination of a patient;
a decision unit configured to decide display information of the clinical data based on a result of analyzing a feature associated with diagnosis by a specific doctor corresponding to identification information input by said input unit by comparing a first learning result based on diagnosis results of case data diagnosed by a plurality of doctors and a second learning result based on a diagnosis result of the case data diagnosed by the specific doctor; and
a display processing unit configured to display, on a display device, a display window based on display information decided by said decision unit.
